(19) United States
(12) Patent Application Publication
(10) Pub. No.: US 2003/0123667 A1
(43) Pub. Date: Jul. 3, 2003

(54) Method for encryption key generation

(75) Inventors: Joseph W. Weber, Louisville, CO (US); James W. Fahrny, Thornton, CO (US)

Correspondence Address: PATTON BOGGS, PO BOX 270930, LOUISVILLE, CO, 80027, US

(73) Assignee: Cable Television Laboratories, Inc.

(21) Appl. No.: 10/035,636

(22) Filed: Dec. 28, 2001

(51) Int. Cl. H04L 9/00

(52) U.S. Cl. 380/277

(57) ABSTRACT

A method for generating an encryption key wherein combinations of a host identification and a content identification are concatenated to produce the encryption key. The content identification is unique to each block of plaintext to be transmitted over an unsecured interface to a storage device. The content identification is appended to the resulting ciphertext for transmission to the storage device. The ciphertext is retrieved by the host device wherein the host identification and appended content identification are used to recreate the encryption key and thus decrypt the ciphertext. Also using a time variable to generate the encryption key provides a method for limiting the duration during which the ciphertext can be decrypted.

### FIELD OF THE INVENTION

The invention relates to transmission of data over an unsecured interface, and in particular to a method for generating an encryption key for encrypting plaintext then later recreates the encryption key for decryption of the data.

### PROBLEM

It is a problem in the field of encrypting data for transmission and storage across an unsecured interface to prevent unauthorized devices from intercepting and decrypting the transmitted data while also providing an encryption key that can be recreated by the encrypting device to later decrypt the stored data without storing the encryption key within the encrypting device.

Reading and writing digital content across an unsecured interface to a storage device exposes the content to possible duplication and theft of information. Data that can be read and understood without any special measures is called plaintext. The method of disguising plaintext in such a way as to hide its message is called encryption. Encrypting plaintext results in unreadable gibberish called ciphertext. Encryption is used to ensure that information is hidden from anyone for whom it is not intended, including those who can see the encrypted data. The process of reverting ciphertext back to its original plaintext is called decryption. Cryptography is the science of using mathematics to encrypt and decrypt data. Cryptography enables the storage of sensitive information or the transmission of the information across an insecure network so that it cannot be read by anyone except the intended recipient.

A cryptographic algorithm, or cipher, is a mathematical function used in the encryption and decryption process. A cryptographic algorithm works in combination with a key—a word, number, or phrase—to encrypt the plaintext. The same plaintext encrypts to different ciphertext with different keys. Therefore, the security of the encrypted data is dependent on two things: the strength of the cryptographic algorithm and the secrecy of the key.

There are two types of encryption. Conventional encryption, also called secret-key or symmetric-key encryption, where one key is used for both encryption and decryption. Another encryption system, public key cryptography, is an asymmetric scheme that uses a pair of keys for encryption: a public key to encrypt the message and a corresponding private key to decrypt the encrypted message. Conventional encryption is fast and is useful for encrypting data that isn't going anywhere. However, a problem with the use conventional encryption for encrypting data that is being transmitted over an insecure interface can be quite expensive due to the difficulty of secure key distribution.

For a sender and recipient to communicate securely using conventional encryption, they must agree upon a key and keep it secret between themselves. If they are at different physical locations, they must distribute the key via some secure communication medium to prevent the disclosure of the secret key during transmission. Anyone who overhears or intercepts the secret key in transit can later read, modify, and forge all information encrypted or authenticated with that secret key. The persistent problem with conventional encryption is key distribution: how to get the key to the recipient without someone intercepting it.

Pretty Good Privacy (PGP)

A know public encryption system is the PGP, which is a hybrid cryptosystem. PGP first compresses the plaintext for two reasons. First compression saves modem transmission time and disk storage space and, more importantly, it strengthens the cyptrographic security. Attackers exploit patterns found in plaintext to crack the cipher. Compression reduces these patterns in the plaintext, thereby greatly enhancing the resistance to attack. Compression within PGP is a one-way hash function which takes a variable length plaintext message and produces a fixed-length hashed value. Hash functions have been used in the computer science industry for a long time. A hash function is a function, mathematical or otherwise, that takes a variable length digital input string and converts it to a fixed length digital output string called a hashed value.

PGP then creates a session key which is a one-time-only secret key randomly generated. The session key along with a conventional encryption algorithm is used to encrypt the plaintext. Once the plaintext is encrypted, the session key is encrypted to the recipient's private key. The public key-encrypted session key is transmitted along with the ciphertext to the recipient. The recipient uses his private key to recover the temporary session key, which is then used to decrypt the conventionally-encrypted ciphertext.

The combination of the two encryption methods combines the convenience of public key encryption with the speed of conventional encryption. Transmitting the public key-encrypted session over an insecure interface renders the PGP encryption system subject to a man-in-the-middle attack. It is possible for an attacker to post a phony public key with the name and identification of the recipient. Data encrypted to the recipient is received by the attacker, the message is now in the wrong hands. Using conventional encryption systems, it is vital that the sender insure that the public key being used to encrypt the session key does in fact belong to the recipient.

Digital Signature Standard (DSS)

Another public encryption system is the digital signature standard (DSS). The security of DSS is dependent on maintaining the secrecy of users' private keys. Users must therefore guard against the unauthorized acquisition of their private keys. The DSS standard specifies general security requirements for generating digital signatures. Digital signatures are used to detect unauthorized modification to data and to authenticate the identity of the signatory. In addition, the recipient of the signed data can use a digital signature in proving to a third party that the signature was in fact generated by the signatory.

Like PGP, DSS uses a secure hash algorithm in conjunction with a digital signature algorithm (DSA) to generate a secure signature for a document and to verify the signature of the received document. The DSA is used by the signatory to generate a digital signature and by the verifier to verify the authenticity of the signature. Each signatory has a public and a private key. The private key is used in the signature generation process and the public key is used in the signature verification process. Signature verification makes use of a public key which corresponds to, but is not the same as, the private key. For both signature generation and verification, the data which is referred to as a message is reduced by means of the secure hash algorithm. An adversary who does not know the private key of the signatory, cannot generate the correct signature of the signatory. In other words, signatures cannot be forged. However, by using the signatory's public key, anyone can verify a correctly signed message.

While the DSS standard just described provides a method for generating a signature from a private signatory key, the method fails to provide a means for protecting the private signatory key. Instead, DSS is dependent on maintaining the secrecy of the users' private key. Users must therefore guard against the unauthorized acquisition of their private keys. Another problem associated with the public key system is that the public and the private keys are mathematically related. Given enough time and computing power, the private key can be derived from the public key.

For these reasons, a need exists for a method creating an encryption key that can be reproduced at a later date for decrypting the data without saving the encryption key on the encrypting device or with the transmitted ciphertext.

### SOLUTION

The present method for encryption key generation overcomes the problems outlined above and advances the art by providing a method of combining the speed of conventional encryption with the security of public key encryption. The host device encrypting the plaintext to be transmitted over the unsecured interface is assigned a host identification. The host identification is stored in a secure location within the host device.

The host identification is analogous to the private key. Only the host device can generate the encryption key used to later decrypt the ciphertext. A second variable, a content identification, is generated by the host device. Each successive block of plaintext to be encrypted uses a different content identification. The host identification along with the content identification is used for generating an encryption key to encrypt a block of plaintext. This second variable, the content identification, is analogous to the public key. The content identification is transmitted with the resulting ciphertext and together the ciphertext and content identification are stored for retrieval at a later time.

The encryption key is generated following a method that can be repeated later using the same host identification and content identification to generate the same encryption key. In other words, the formula used to generate the encryption key is deterministic. In an embodiment all combinations of the host identification and the content identification are concatenated to generate the encryption key. Following the same method in reverse using the retrieved content identification in conjunction with host identification generates the same combinations. Concatenating the same combinations in the same order produces the same encryption key for decrypting the ciphertext.

In an alternative embodiment, a time variable is also used to generate the encryption key. In this embodiment, the time variable provides a method for generating an encryption key to encrypt plaintext that must be retrieved and deciphered within a specific time period. When the specific time period has elapsed, the time variable used to generate the encryption key will have changed. Thus, generating a different encryption key. In this embodiment, decryption of the ciphertext is for a limited time only.

### BRIEF DESCRIPTION OF THE DRAWINGS

FIG. 1 illustrates a block schematic diagram of a host device for use with the method for encryption key generation;

FIG. 2 illustrates combinations of the host identification and content identification used to generate the encryption key;

FIG. 3 illustrates combination of the host identification, content identification, and time used to generate the encryption key in an alternative embodiment;

FIG. 4 illustrates a flow diagram for encrypting plaintext using the present method for encryption key generation; and

FIG. 5 illustrates a flow diagram for decrypting ciphertext using the present method for encryption key generation.

### DETAILED DESCRIPTION

The invention summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

Reading and writing digital content across an unsecured interface to a storage device exposes the content to possible duplication and theft of information. Data that can be read and understood without any special measures is called plaintext. The method of disguising plaintext in such a way as to hide its message is called encryption. Encrypting plaintext results in unreadable gibberish called ciphertext. Encryption is used to ensure that information is hidden from anyone for whom it is not intended, including those who can see the encrypted data. The process of reverting ciphertext back to its original plaintext is called decryption. Cryptography is the science of using mathematics to encrypt and decrypt data. Cryptography enables the storage of sensitive information or the transmission of the information across an insecure network so that it cannot be read by anyone except the intended recipient.

A cryptographic algorithm, or cipher, is a mathematical function used in the encryption and decryption process. A cryptographic algorithm works in combination with a key—a word, number, or phrase—to encrypt the plaintext. The same plaintext encrypts to different ciphertext with different keys. Therefore, the security of the encrypted data is dependent on two things: the strength of the cryptographic algorithm and the secrecy of the key.

There are two types of encryption. Conventional encryption where one key is used for both encryption and decryption and public key cryptography, an asymmetric scheme that uses a pair of keys for encryption: a public key to encrypt the message and a corresponding private key to decrypt the encrypted message. The present method for encryption key generation provides a method for generating an encryption key for use with a conventional encryption system wherein the key can later be recreated for use in decrypting the ciphertext. Typically, conventional encryption is fast and therefore useful for encrypting data that isn't going anywhere. However, a problem with the use conventional encryption for encrypting data that the difficulty of secure key distribution.

Using the present method for encryption key generation, an encryption key is generated wherein only a portion of the encryption key is distributed with the ciphertext. The other portion of the encryption key remains with the host device that generated the encryption key. Thus, only the host device that encrypted the data has the information necessary to recreate the encryption key to decrypt the resulting ciphertext. The method combines conventional and public key cryptography. One portion of the encryption key is analogous to the public key and transmitted with the ciphertext while the portion of the key that remains with the encryption device is analogous to the private key. Like conventional cryptography, the same key that is used to encrypt the data is used to decrypt the data.

Thus, the present method for encryption key generation allows businesses that transmit secure data over an unsecured interface for storage at another location to encrypt the data for transmission, transmit the ciphertext with a portion of the encryption key, then later retrieve the ciphertext and recreate the encryption key to decrypt the ciphertext. The combination of the two encryption methods combines the convenience of public key encryption with the speed of conventional encryption. Used together, the present method for encryption key generation improves performance and encryption key distribution.

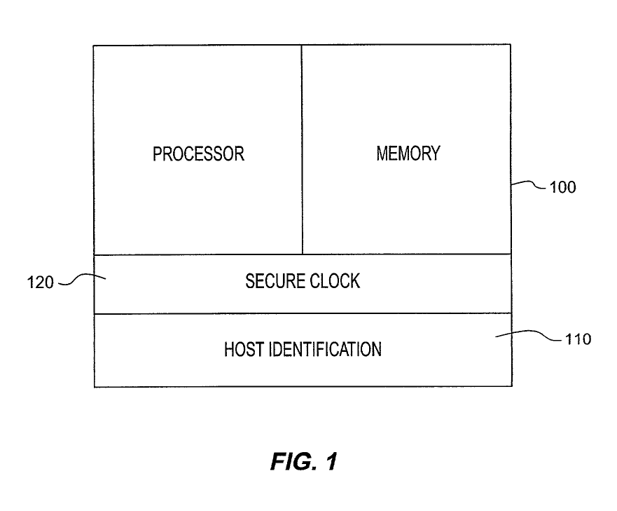

Encryption Key Generation—FIG. 1:

The present method for encryption key generation uses a pseudo public key and pseudo private key. In this embodiment, the public key is a content identification number and the private key is a host identification.

Referring to FIG. 1, the host device 100 generating the encryption key includes host identification 110 stored in a secure location within the host device, thus resembling a private key. The private portion of the key, the host identification, is unique to the device, therefore generating an encryption key that cannot be generated by a host device having a different host identification. The public portion of the encryption key is the content identification.

The content identification is a unique identification that is generated by host device 100. Each block of data to be transmitted is assigned a unique content identification. The unique content identification can be a randomly generated code, can be created sequentially or another method of setting the content identification could be substituted. Other known methods for generating a content identification include randomly selecting an initial content identification code and incrementing the content identification for transmission of successive blocks or the initial content identification could be derived from a protocol such as Realtime Transport Protocol (RTP). Those skilled in the art will appreciate that alternative methods of generating a content identification can be substituted.

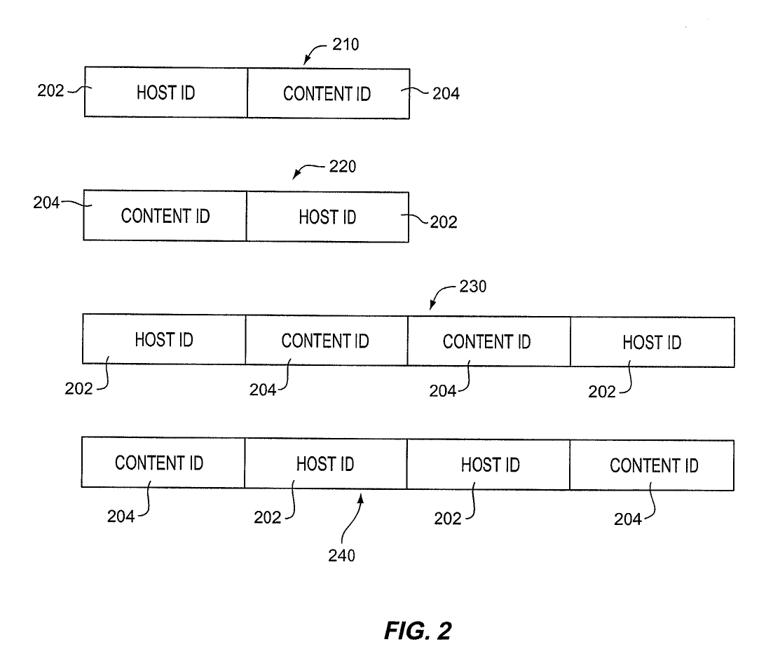

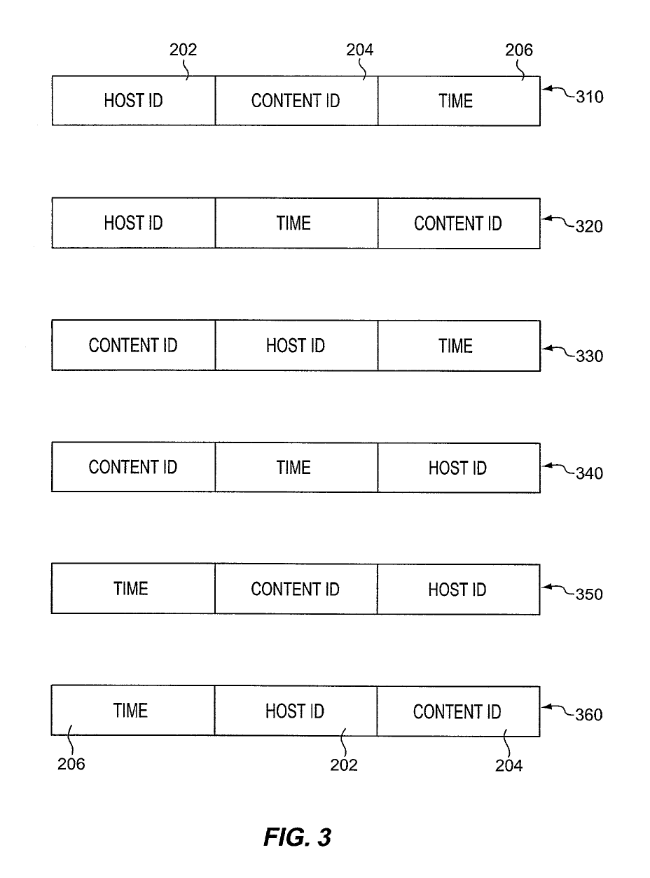

Encryption and Transmission—FIGS. 2 and 3:

For each block of plaintext that is to be transmitted across an unsecured interface, a content identification is generated. Using the host identification and the content identification, the host device generates an encryption key having the following properties. First, the host device generates an encryption key containing each possible combination of host identification and content identification. Referring to FIG. 2, a first combination 210 is host identification 202 followed by content identification 204. A second combination 220 is content identification 204 followed by host identification 202. The formula for generating the encryption key may concatenate the first combination followed by the second combination to produce a longer encryption key 230, 240. Encryption key size is measured in bits. In this example, a one-byte host identification combined with a one-byte content identification results in an encryption key of four bytes. Increasing the size of the host identification and/or the content identification results in a larger key size. In public key encryption, the larger the key, the more secure the ciphertext.

The encryption key could also be generated from an eight-byte host identification and an eight-byte content identification. In this example, the first combination 210 is exclusive ORed with second combination 220 using modulo 256 arithmetic calculations. Thus, producing an eight-byte encryption key that is more secure. Those skilled in the art will recognize that alternative methods of coalescing the host identification and the content identification may be substituted to generate the encryption key. Concatenating or exclusive ORing the host identification and the content identification are for illustration and not intended as a limitation.

Whichever method is followed to generate the encryption key from a combination of the host identification and the content identification, the same method is used to generate all encryption keys. Using the same method to combine the host identification and the content identification to generate the encryption key results in an encryption key that is deterministic. In other words, using the same host identification and the same content identification to generate the encryption key will always produce the same encryption key.

Generating an encryption key using a host identification provides a method for preventing another device from decrypting the ciphertext. If another device recovered the content identification appended to the ciphertext, the encryption key generated by that device would combine the host identification and the content identification to generate the encryption key. Since the host identification is different, the encryption key generated would be different even if the same method of generating the encryption key were followed.

In an alternative embodiment, a third variable is included with the host identification and the content identification to generate the encryption key. In this embodiment, time is the third variable and the time is produced by secure clock 120 within the host device 100 shown in FIG. 1. Referring to FIG. 3, adding the third variable of time produces six unique combinations 310, 320, 330, 340, 350 and 360. Using the example where each variable, host identification 202, content identification 204 and time 206, are each one-byte in length, concatenation of the six combinations produces an eighteen-byte encryption key. As discussed previously, increasing the size of the host identification, content identification and/or the time variable can increase the length of the encryption key.

Adding the third variable of time increases the security of the encryption key. For each subsequent block of plaintext to be transmitted over the unsecured interface, the content identification can be incremented and a new time variable used. In this example the time variable is the time when the encryption key is generated. Using a new time variable to generate a new encryption key provides a method for increasing the security of the encryption key and thus the resulting ciphertext. Changing the content identification and the time variable for each successive block of plaintext provides a method for generating a unique encryption key for each successive block of plaintext.

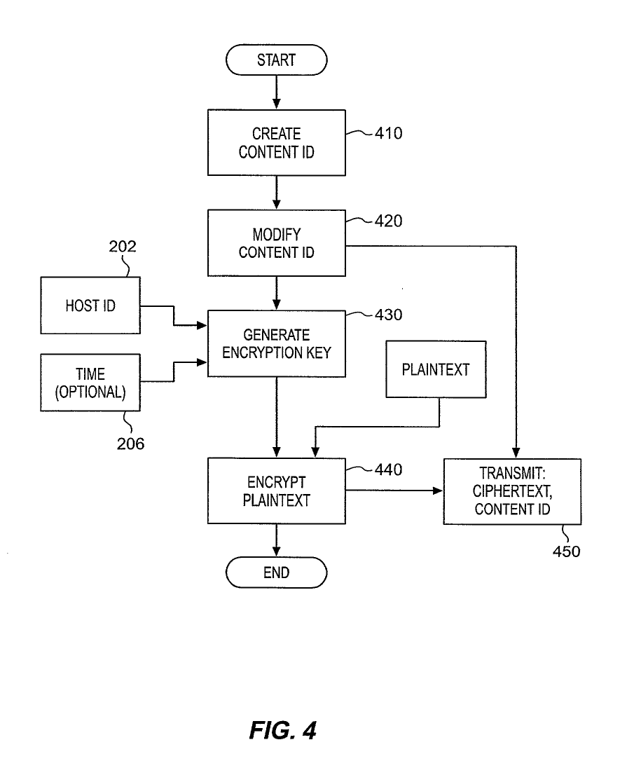

Encryption and Storage of Plaintext—FIGS. 1 and 4:

Referring to the flow diagram in FIG. 4, as previously discussed, in block 410 a unique content identification is generated by the host device. For each successive block of plaintext to be transmitted, either a new content identification is created in block 410 or the previous content identification is incremented or otherwise modified in block 420. Using host identification 202 and the content identification from block 420, an encryption key is generated. In an embodiment previously discussed, the encryption key is a concatenation of all combinations of the host identification and the content identification. In an alternative embodiment, time variable 206 is also used to generate the unique encryption key in block 430.

Using the unique encryption key generated in block 430, the block of plaintext is encrypted in block 440 using a standard block cipher encryption method such as data encryption standard (DES), triple DES, advanced encryption standard (AES) or other standard block cipher encryption method. The content identification is appended to the resulting ciphertext and the ciphertext and appended content identification are transmitted in block 450 over the unsecured interface for storage on the storage device.

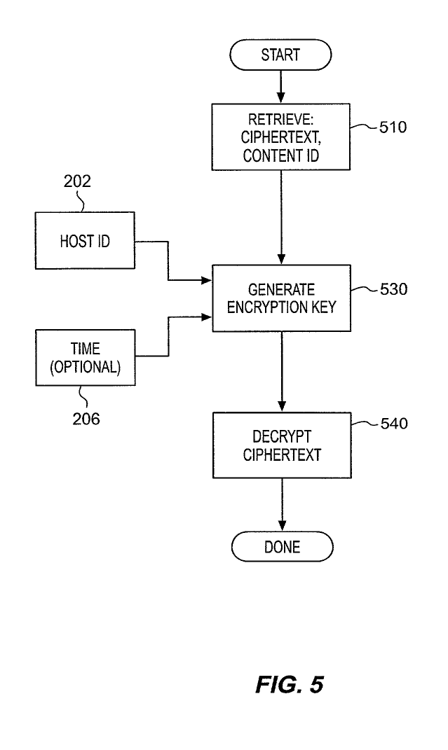

Retrieval and Decryption of Plaintext—FIGS. 4 and 5:

Referring to FIG. 5, when use of the previously encrypted plaintext is required, the ciphertext and appended content identification are retrieved in block 510 from the storage device. Using the appended content identification in conjunction with host identification 202, the encryption key is recreated. Whichever method was followed to generate the encryption key from a combination of the host identification and the content identification in block 430 for encrypting the plaintext, the same method is used to generate the encryption key in block 530 for decrypting the ciphertext.

As previously discussed, using the same method to combine the host identification and the content identification to generate the encryption key results in an encryption key that is deterministic. In other words, using the same host identification and the same content identification to generate the encryption key will always produce in the same encryption key. Referring to FIGS. 4 and 5, the encryption keys generated in blocks 430 and 530 are the same encryption keys. The encryption key generated in block 530 is used in block 540 to decrypt the ciphertext retrieved in block 510.

In the alternative embodiment, the time variable 206 is used to generate the encryption key in blocks 430 and 530 is a time element, such as the month and year. In this embodiment the time variable is not stored with the ciphertext. Instead, when the ciphertext is decrypted, the same time element is used, the month and the year in this example. If the month has changed, the encryption key generated in block 530 will not match the encryption key generated in block 430. Thus, the ciphertext cannot be decrypted. Adding the time variable to the present method for encryption key generation prevents a user from retrieving and decrypting outdated information.

An example of a use for an encryption key that expires is video transmission such as pay-for-view. In this example, the ordered digital video content is encrypted using a unique content identification and the host identification that ordered the video. This results in an encrypted video stream that can only be decrypted by the host device, similar to public key encryption. Adding a time variable to the encryption key generation prevents the encrypted video from being decrypted at a later time or from being decrypted by a device other than the specific host device. While the time variable has been described using digital video, the use is for illustration only and not as a limitation. The time variable can also be used for securing audio content, digital files and databases, just to name a few alternative uses.

As to alternative embodiments, those skilled in the art will appreciate that the present method for encryption key generation may be implemented with alternative size variables. While the generation of the encryption has been discussed using one-byte host identification and a one-byte content identification, the size is for illustration. Those skilled in the art of encryption key generation will appreciate that alternative size variables can be substituted. Likewise, although the content identification can be incremented for each successive block of plaintext, alternative methods of modifying or creating a new content identification for each successive block of plaintext can be substituted.

It is apparent that there has been described a method for encryption key generation that fully satisfies the objects, aims, and advantages set forth above. While the method for encryption key generation has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A method for generating an encryption key for use with a host device having a host identification stored therein, the method comprising:
retrieving the host identification from the host device;
generating at least one content variable;
combining the host identification and the at least one content variable to produce two or more combinations, wherein the method used to combine the host identification and the at least one content variable repeatedly produces the same two or more combinations; and
coalescing the two or more combinations to produce the encryption key, wherein the method of coalescing the two or more combinations repeatedly produces the same encryption key.

2. The encryption key generation method of claim 1 wherein coalescing the two combinations comprises:
concatenating the two or more combinations using a predetermined method, wherein concatenating the two or more combinations repeatedly produces the same encryption key.

3. The method of claim 1, wherein the host device includes a secure clock, the method further comprising:
obtaining a time variable from the secure clock within the host device;
combining the host identification, the at least one content variable and the time variable to produce a plurality of different combinations, wherein the method used to combine the host identification, the at least one content variable and the time variable repeatedly produces the same plurality of different combinations; and
coalescing the plurality of different combinations to produce the encryption key, wherein the method of coalescing the plurality of different combinations repeatedly produces the same encryption key.

4. A method for generating an encryption key to encrypt a block of plaintext for use with a host device having a secure clock and a host identification assigned thereto and saved therein, the method comprising:
retrieving the host identification from the host device;
generating a content identification, wherein the content identification corresponds to the block of plaintext;
obtaining a time variable from the secure clock within the host device;
combining the host identification, the content identification and the time variable to produce at least six combinations thereof; and
coalescing the at least six combinations to generate the encryption key, wherein the method of coalescing the at least six combinations repeatedly produces the same encryption key.

5. A method for encrypting a block of plaintext for transmission over an unsecured interface to a storage device, for use with a host device having a host identification assigned thereto and stored therein, the method comprising:
retrieving the host identification from the host device;
generating at least one content variable;
combining the host identification and the at least one content variable to produce two or more combinations, wherein the method used to combine the host identification and the at least one content variable repeatedly produces the same two or more combinations;
coalescing the two or more combinations to produce a first encryption key, wherein the method of coalescing the two or more combinations repeatedly produces the same first encryption key;
encrypting the block of plaintext using the first encryption key to produce a block of ciphertext;
appending the at least one content variable to the block of ciphertext;
transmitting the block of ciphertext and the appended at least one content variable over the unsecured interface to the storage device; and
storing the block of ciphertext and the appended one or more content variables within the storage device.

6. The method of encrypting the block of plaintext of claim 5, wherein the host device further comprises a secure clock, the method further comprising:
obtaining a first time variable from the secure clock within the host device;
combining the host identification, the at least one content variable and the first time variable to produce a first plurality of different combinations, wherein the method used to combine the host identification, the at least one content variable and the first time variable repeatedly produces the same first plurality of different combinations; and
coalescing the first plurality of different combinations to produce the first encryption key, wherein the method of coalescing the first plurality of combinations repeatedly produces the same first encryption key.

7. The method of encrypting the block of plaintext of claim 6, for further use decrypting the block of ciphertext, the method comprising:
retrieving the stored block of ciphertext and the appended at least one content variable from the storage device;
retrieving the host identification from the host device;
obtaining a second time variable from the secure clock within the host device;
combining the host identification, the at least one content variable and the second time variable to produce a second plurality of different combinations; and
coalescing the second plurality of different combinations to produce a second encryption key, wherein if the first time variable and the second time variable do not match, the second encryption key will not decrypt the block of ciphertext and if the first time variable matches the second time variable the second encryption key will decipher the block of ciphertext.

8. The method of encrypting the block of plaintext of claim 5 for further use decrypting the stored block of ciphertext, the method comprising:
retrieving the stored block of ciphertext and the appended at least one content variable from the storage device;
retrieving the host identification from the host device;
combining the host identification and the at least one content variables to produce two or more combinations;
coalescing the two or more combinations to produce the encryption key; and
decrypting the block of ciphertext with the encryption key to produce the block of plaintext.
